(19) United States
(12) Patent Application Publication
(10) Pub. No.: US 2026/0233541 A1
(43) Pub. Date: Aug. 13, 2026

(54) RECORDING APPARATUS

(71) Applicant: SEIKO EPSON CORPORATION, TOKYO (JP)

(72) Inventors: Kohei OKAWA, MATSUMOTO-SHI (JP); Katsumi YAMADA, MATSUMOTO-SHI (JP); Hiroki SHINAGAWA, SHIOJIRI-SHI (JP); Takumi Watanabe, MATSUMOTO-SHI (JP); Natori KADOTA, MATSUMOTO-SHI (JP)

(21) Appl. No.: 19/538,033

(22) Filed: Feb. 12, 2026

(30) Foreign Application Priority Data
Feb. 12, 2025 (JP) 2025-020578

(51) Int. Cl. B41J 29/00; B41J 2/165; B41J 13/02; B41J 13/03; B41J 25/00; F16H 1/22

(52) U.S. Cl. CPC B41J 29/00; B41J 2/16505; B41J 13/025; B41J 13/03; B41J 25/001; F16H 1/22; B41J 2002/16594; B41P 2235/27

(57) ABSTRACT

A recording apparatus includes a motor that is a common driving source for a first roller pair, a second roller pair, and a suction pump. A clutch is provided between a first power transmission section that transmits power of the motor to the first roller pair and the second roller pair and, of the second roller pair, a drive roller driven by the power of the motor. The clutch transmits the power of the motor when the motor rotates in a forward rotation direction and interrupts the transmission of the power of the motor when the motor rotates in a reverse rotation direction.

The present application is based on, and claims priority from JP Application Serial Number 2025-020578, filed Feb. 12, 2025, the disclosure of which is hereby incorporated by reference herein in its entirety.

### BACKGROUND

### 1. Technical Field

The present disclosure relates to a recording apparatus that performs recording on a medium.

### 2. Related Art

In a recording apparatus represented by an inkjet printer, a plurality of driving targets are sometimes driven by one motor in order to suppress an increase in cost. In the recording apparatus described in JP-A-2013-39805, an intermediate roller, a conveyance roller, a paper discharge roller, and a suction pump are driven by one motor. The intermediate roller rotates forward regardless of a rotation direction of the motor. The conveyance roller and the paper discharge roller rotate forward when the motor rotates forward and reversely rotate when the motor reversely rotates. The suction pump is driven only when the motor reversely rotates.

The recording apparatus described in JP-A-2013-39805 determines, in view of the fact that, when the motor is reversely rotated for driving the suction pump, the intermediate roller and the conveyance roller are likely to rotate in the opposite directions to each other to cause a jam, whether a PE sensor for detecting a paper end has detected a paper leading end at the time of the driving of the suction pump. The PE sensor is disposed in the front of the conveyance roller. When the PE sensor detects the paper leading end at the time of the driving of the suction pump, the motor is stopped.

Although the PE sensor is not disclosed in detail in JP-A-2013-39805, as the PE sensor, there is a non-contact type PE sensor that does not come into contact with a medium and a contact type PE sensor that comes into contact with a medium. In particular, the contact type PE sensor is sometimes adopted from the viewpoint of suppressing an increase in cost and suppressing erroneous detection. As an example of the contact type PE sensor, as described in JP-A-2004-352416, a lever capable of swinging in contact with a medium is sometimes used.

JP-A-2013-39805 and JP-A-2004-352416 are examples of the related art.

In the recording apparatus described in JP-A-2004-352416, a lever is configured to swing in contact with a medium conveyed from upstream to downstream and is not configured to swing in contact with a medium reversely fed from downstream to upstream. When the contact type PE sensor explained above is used, it is not only likely that the medium cannot be detected even if the leading end of the reversely fed medium comes into contact with the lever but also likely that a jam due to the leading end of the medium coming into contact with the lever is likely to occur.

In addition, when the PE sensor is not provided upstream of the conveyance roller in the first place, it is also likely that a medium cannot be detected and a jam occurs because the leading end of the medium comes into contact with a part other than the PE sensor upstream of the conveyance roller.

Therefore, it is desired to, without using the PE sensor disposed upstream of the conveyance roller, suppress a jam that occurs when the motor is reversely rotated for driving the suction pump.

### SUMMARY

According to an aspect of the present disclosure, there is provided a recording apparatus including: a conveyance path for conveying a medium; a recording head configured to perform recording on the medium in the conveyance path; a first roller pair provided upstream of the recording head in the conveyance path and configured to convey the medium; a second roller pair provided downstream of the recording head in the conveyance path and configured to convey the medium; a cap facing the recording head; a suction pump coupled to the cap; a motor that is a common driving source for the first roller pair, the second roller pair, and the suction pump; a first power transmission section configured to transmit power of the motor to the first roller pair and the second roller pair; a second power transmission section configured to set, as a forward rotation direction, a rotation direction of the motor at a time when the medium is conveyed downstream by the first roller pair and the second roller pair and transmit the power of the motor to the suction pump when the motor rotates in a reverse rotation direction opposite to the forward rotation direction; and a clutch provided between, of the second roller pair, a drive roller driven by the power of the motor and the first power transmission section, wherein the clutch transmits the power of the motor when the motor rotates in the forward rotation direction and interrupts the transmission of the power of the motor when the motor rotates in the reverse rotation direction.

According to an aspect of the present disclosure, there is provided a recording apparatus including: a conveyance path for conveying a medium; a recording head configured to perform recording on the medium in the conveyance path; a first roller pair provided upstream of the recording head in the conveyance path and configured to convey the medium; a second roller pair provided downstream of the recording head in the conveyance path and configured to convey the medium; a cap facing the recording head; a suction pump coupled to the cap; a motor that is a common driving source for the first roller pair, the second roller pair, and the suction pump; a first power transmission section configured to transmit power of the motor to the first roller pair and the second roller pair; and a second power transmission section configured to set, as a forward rotation direction, a rotation direction of the motor at a time when the medium is conveyed downstream by the first roller pair and the second roller pair and transmit the power of the motor to the suction pump when the motor rotates in a reverse rotation direction opposite to the forward rotation direction, wherein the second roller pair includes a drive roller driven by the motor and a driven roller driven to rotate while nipping the medium between the driven roller and the drive roller, the driven roller is rotatably supported by a movable frame, the movable frame is displaceable to a first position where the driven roller is capable of nipping the medium between the driven roller and the drive roller and a second position where the driven roller separates from the drive roller, and the movable frame is disposed at the first position when the motor rotates in the forward rotation direction and is disposed at the second position when the motor rotates in the reverse rotation direction.

### BRIEF DESCRIPTION OF THE DRAWINGS

FIG. 1 is an exterior perspective view of a printer.

FIG. 2 is a diagram illustrating a medium conveyance path of the printer.

FIG. 3 is a block diagram illustrating a control system of the printer.

FIG. 4 is a perspective view of a maintenance unit.

FIG. 5 is a perspective view of a power transmission section that transmits power from a conveyance motor to a suction pump.

FIG. 6 is a perspective view of a time lag mechanism.

FIG. 7 is a cross-sectional view of the time lag mechanism.

FIG. 8 is a diagram illustrating a state change of a lever configuring a medium detection section.

FIG. 9 is a diagram illustrating a part of the medium conveyance path.

FIG. 10 is a perspective view of a clutch.

FIG. 11 is an exploded perspective view of the clutch.

FIG. 12 is a perspective view of a first gear.

FIG. 13A is a perspective view of a second gear.

FIG. 13B is a perspective view of the second gear.

FIG. 14 is a perspective view of a third gear.

FIG. 15A is a perspective view of the clutch and is a diagram illustrating a power transmission state.

FIG. 15B is a perspective view of the clutch and is a diagram illustrating the power transmission state.

FIG. 16A is a perspective view of the clutch and is a diagram illustrating a state in which the conveyance motor is reversely rotated from the power transmission state.

FIG. 16B is a perspective view of the clutch and is a diagram illustrating a state in which the conveyance motor is reversely rotated from the power transmission state.

FIG. 17A is a diagram illustrating a state in which the conveyance motor is further reversely rotated from the state illustrated in FIG. 16A.

FIG. 17B is a diagram illustrating a state in which the conveyance motor is further reversely rotated from the state illustrated in FIG. 16B.

FIG. 18 is a perspective view of the clutch and is a diagram illustrating a modification of the second gear.

FIG. 19 is a plan view of a fixed frame, a movable frame, and a rack member, and is a diagram illustrating a state in which the rack member is not engaged with a carriage.

FIG. 20 is a plan view of the fixed frame, the movable frame, and the rack member and is a diagram illustrating a state in which the rack member is displaced by receiving an external force from the carriage.

FIG. 21 is a cross-sectional view of the fixed frame and the movable frame taken along an X-Z plane and is a diagram illustrating a state in which the rack member is not engaged with the carriage.

FIG. 22 is a cross-sectional view of the fixed frame and the movable frame taken along the X-Z plane and is a diagram illustrating a state in which the rack member is displaced by receiving an external force from the carriage.

### DESCRIPTION OF EMBODIMENTS

The present disclosure is schematically explained below.

According to a first aspect of the present disclosure, there is provided a recording apparatus including: a conveyance path for conveying a medium; a recording head configured to perform recording on the medium in the conveyance path; a first roller pair provided upstream of the recording head in the conveyance path and configured to convey the medium; a second roller pair provided downstream of the recording head in the conveyance path and configured to convey the medium; a cap facing the recording head; a suction pump coupled to the cap; a motor that is a common driving source for the first roller pair, the second roller pair, and the suction pump; a first power transmission section configured to transmit power of the motor to the first roller pair and the second roller pair; a second power transmission section configured to set, as a forward rotation direction, a rotation direction of the motor at a time when the medium is conveyed downstream by the first roller pair and the second roller pair and transmit the power of the motor to the suction pump when the motor rotates in a reverse rotation direction opposite to the forward rotation direction; and a clutch provided between, of the second roller pair, a drive roller driven by the power of the motor and the first power transmission section, wherein the clutch transmits the power of the motor when the motor rotates in the forward rotation direction and interrupts the transmission of the power of the motor when the motor rotates in the reverse rotation direction.

According to this aspect, the clutch prevents the second roller pair from rotating when the motor rotates in the reverse rotation direction. For this reason, when the motor is rotated in the reverse rotation direction, it is possible to prevent the medium from being sent upstream of the conveyance path and it is possible to suppress occurrence of a jam.

A second aspect is an aspect dependent from the first aspect, wherein the clutch includes: a first gear configured to rotate together with the drive roller; a second gear configured to mesh with the first gear when the motor rotates in the forward rotation direction and not to mesh with the first gear when the motor rotates in the reverse rotation direction; and a third gear to which power is transmitted from the first power transmission section, the third gear transmitting power to the second gear, the first gear, the second gear, and the third gear are disposed along a rotation axis of the drive roller, the first gear includes a first tooth protruding toward the second gear, the second gear includes a second tooth protruding toward the first gear, and the second tooth meshes with the first tooth when the motor rotates in the forward rotation direction and does not mesh with the first tooth when the motor rotates in the reverse rotation direction.

According to this aspect, the clutch can be configured in a simple structure by the first gear, the second gear, and the third gear. Since the first gear, the second gear, and the third gear are disposed along the rotation axis of the drive roller, it is possible to prevent the clutch from increasing in size in the radial direction of the drive roller.

A third aspect is an aspect dependent from the second aspect, wherein a first inclined surface inclined in a direction in which a tooth height decreases from the first tooth is formed in the first gear, and the second tooth slides on the first inclined surface when the motor rotates in the reverse rotation direction.

According to this aspect, the second tooth slides on the first inclined surface when the motor rotates in the reverse rotation direction. For this reason, it is possible to easily obtain a configuration in which the second tooth does not mesh with the first tooth when the motor rotates in the reverse rotation direction.

A fourth aspect is an aspect dependent from the third aspect, wherein the second gear includes a third tooth and a fourth tooth protruding toward the third gear, the third tooth and the fourth tooth are provided at an interval in the rotation direction, the third gear includes a fifth tooth protruding toward the second gear, the fifth tooth meshes with the third tooth when the motor rotates in the forward rotation direction and meshes with the fourth tooth when the motor rotates in the reverse rotation direction, when the fifth tooth meshes with the third tooth, movement of the second gear along the rotation axis is restricted between the first gear and the third gear to maintain a state in which the first tooth and the second tooth mesh with each other, and, when the fifth tooth meshes with the fourth tooth, movement of the second gear along the rotation axis is allowed between the first gear and the third gear and thus the second tooth slides on the first inclined surface.

According to this aspect, when the motor rotates in the reverse rotation direction, the movement of the second gear along the rotation axis is allowed between the first gear and the third gear. For this reason, it is possible to implement a configuration in which the second tooth slides on the first inclined surface.

Since the fifth tooth meshes with the fourth tooth when the motor rotates in the reverse rotation direction, the fifth tooth can quickly mesh with the third tooth when the motor rotates in the forward rotation direction from this state.

A fifth aspect is an aspect dependent from the fourth aspect, wherein the third gear includes a sixth tooth protruding toward the second gear, the fifth tooth and the sixth tooth are provided at an interval in the rotation direction, and the sixth tooth meshes with the fourth tooth when the motor rotates in the forward rotation direction and meshes with the third tooth when the motor rotates in the reverse rotation direction.

According to this aspect, the sixth tooth provided in the third gear meshes with the fourth tooth when the motor rotates in the forward rotation direction and meshes with the third tooth when the motor rotates in the reverse rotation direction.

Therefore, when the motor rotates in the forward rotation direction, the fifth tooth meshes with the third tooth and the sixth tooth meshes with the fourth tooth. Here, if the sixth tooth is not provided and only the fifth tooth and the third tooth mesh with each other in the rotation direction, it is likely that the second gear tilts with respect to the rotation axis and the movement of the second gear becomes stiff.

However, as explained above, when the motor rotates in the forward rotation direction, the fifth tooth meshes with the third tooth and the sixth tooth meshes with the fourth tooth. For this reason, it is possible to suppress the tilt of the second gear and it is possible to prevent the movement of the second gear from becoming stiff.

The same applies when the motor rotates in the reverse rotation direction. When the motor rotates in the reverse rotation direction, the fifth tooth meshes with the fourth tooth and the sixth tooth meshes with the third tooth. For this reason, it is possible to suppress the tilt of the second gear and it is possible to prevent the movement of the second gear from becoming stiff.

A sixth aspect is an aspect dependent from any one of the second to fifth aspects, wherein a plurality of the first teeth are provided in the first gear at intervals in the rotation direction.

If there is only one first tooth, it is likely that time is required for the second tooth to mesh with the first tooth when the motor switches the rotation from the reverse rotation direction to the forward rotation direction.

However, according to this aspect, the plurality of first teeth are provided at intervals in the rotation direction. For this reason, the second tooth can quickly mesh with the first teeth when the motor switches the rotation from the reverse rotation direction to the forward rotation direction.

A seventh aspect is an aspect dependent from the sixth aspect, wherein a plurality of the second teeth are provided at intervals in the rotation direction in the second gear.

If there is only one second tooth in the second gear, it is likely that the second gear tilts with respect to the rotation axis and the movement of the second gear becomes stiff.

However, according to this aspect, since the plurality of second teeth are provided at intervals in the rotation direction, it is possible to suppress the tilt of the second gear and it is possible to prevent the movement of the second gear from becoming stiff.

This aspect may be dependent from any one of the second to fifth aspects explained above without being limited to the sixth aspect.

According to an eighth aspect of the present disclosure, there is provided a recording apparatus including: a conveyance path for conveying a medium; a recording head configured to perform recording on the medium in the conveyance path; a first roller pair provided upstream of the recording head in the conveyance path and configured to convey the medium; a second roller pair provided downstream of the recording head in the conveyance path and configured to convey the medium; a cap facing the recording head; a suction pump coupled to the cap; a motor that is a common driving source for the first roller pair, the second roller pair, and the suction pump; a first power transmission section configured to transmit power of the motor to the first roller pair and the second roller pair; and a second power transmission section configured to set, as a forward rotation direction, a rotation direction of the motor at a time when the medium is conveyed downstream by the first roller pair and the second roller pair and transmit the power of the motor to the suction pump when the motor rotates in a reverse rotation direction opposite to the forward rotation direction, wherein the second roller pair includes: a drive roller driven by the motor; and a driven roller driven to rotate while nipping the medium between the driven roller and the drive roller, the driven roller is rotatably supported by a movable frame, the movable frame is displaceable to a first position where the driven roller is capable of nipping the medium between the driven roller and the drive roller and a second position where the driven roller separates from the drive roller, and the movable frame is disposed at the first position when the motor rotates in the forward rotation direction and is disposed at the second position when the motor rotates in the reverse rotation direction.

According to this aspect, the movable guide member is located at the first position when the motor rotates in the forward rotation direction and is located at the second position when the motor rotates in the reverse rotation direction. For this reason, even when the motor rotates in the reverse rotation direction and the drive roller reversely rotates, it is possible to prevent the medium from being sent upstream of the conveyance path and it is possible to suppress occurrence of a jam.

A ninth aspect is an aspect dependent from the eighth aspect, further including: a carriage movable in a width direction intersecting a conveyance direction of the medium and including the recording head; and a slide member that is a member configured to engage with the movable frame, when the carriage moves to an outer side of a recording region where recording is performed on the medium, the slide member receiving, from the carriage, an external force moving in the width direction, wherein the movable frame is pressed toward the second position by a pressing member, and, when the external force is not received from the carriage, the slide member holds the movable frame at the first position against a pressing force of the pressing member and receives the external force from the carriage and moves in the width direction to allow displacement of the movable frame toward the second position.

According to this aspect, since the movable frame is displaced to the first position and the second position by the operation of the carriage, a dedicated power source for displacing the movable frame is unnecessary and it is possible to suppress an increase in cost of the apparatus.

Hereinafter, the present disclosure is specifically explained.

An inkjet printer 1 that ejects ink, which is an example of liquid, to perform recording on a medium represented by recording paper is explained below as an example of a recording apparatus. The inkjet printer 1 is hereinafter abbreviated as printer 1.

An X-Y-Z coordinate system illustrated in the figures is an orthogonal coordinate system. A Y-axis direction is a conveyance direction of the medium at the time of recording and is the apparatus depth direction. In the present embodiment, among side surfaces forming the periphery of the printer 1, a side surface on a +Y direction side is a front surface and a side surface on a −Y direction side is a back surface.

An X-axis direction is the apparatus width direction and a +X direction side is the left side and a −X direction side is the right side when viewed from an operator of the printer 1. The X-axis direction is the medium width direction.

A Z-axis direction is the vertical direction, that is, the apparatus height direction and a +Z direction is the upward direction and a −Z direction is the downward direction.

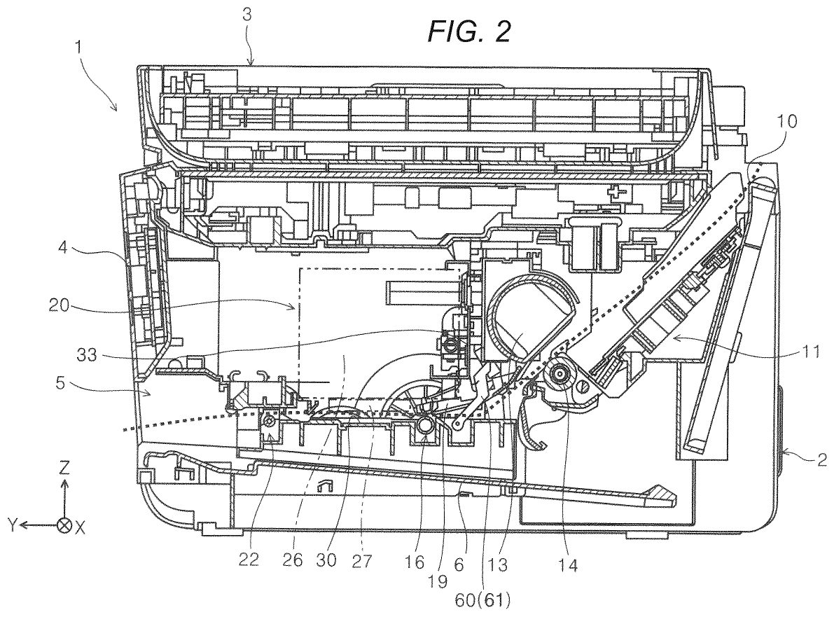

Hereinafter, a direction in which the medium is sent is sometimes referred to as “downstream” and the opposite direction thereof is sometimes referred to as “upstream”. In FIG. 2, a conveyance path 10 of the medium is indicated by a broken line. In the printer 1, the medium is conveyed through the conveyance path 10.

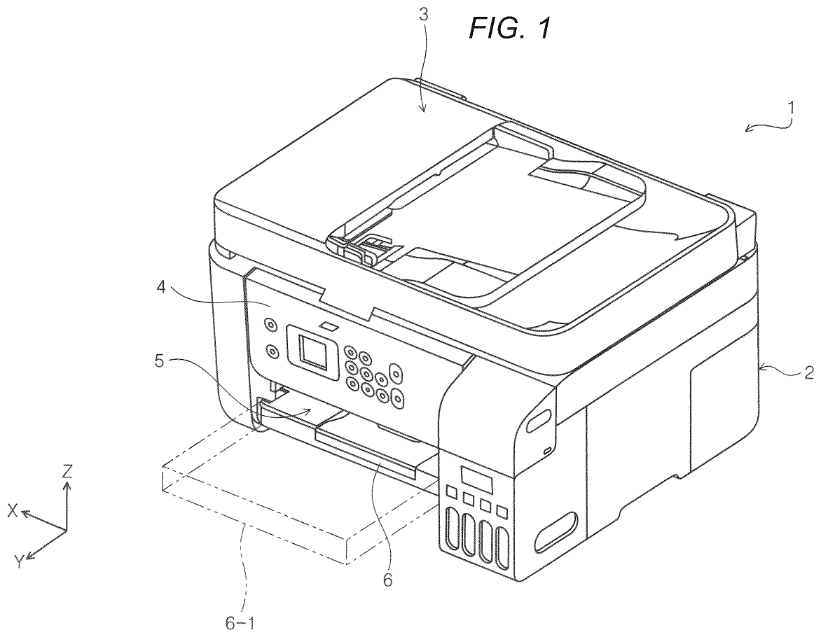

As illustrated in FIGS. 1 and 2, the printer 1 is configured as a multifunction peripheral including a recording unit 2 and a scanner section 3 disposed above the recording unit 2. An operation panel 4 is provided on the apparatus front side of the recording unit 2.

A discharge port 5 is formed on the front side of the recording unit 2. A medium receiving tray 6 is provided in the discharge port 5. The medium receiving tray 6 is configured to be capable of switching a housed state (a solid line in FIG. 1) and a pulled-out state (an alternate long and two-short dashes line indicated by reference sign 6-1 in FIG. 1) with respect to the recording unit 2.

As illustrated in FIG. 2, a medium support section 11 that supports, in an inclined posture, the medium to be fed is provided upstream of the conveyance path 10. The medium in the present embodiment includes, for example, media having different sizes such as A4 size paper and B5 size paper, photographic paper, or a postcard.

The medium supported by the medium support section 11 is nipped by a feeding roller 13 and a separation roller 14 and sent toward a conveyance roller pair 16. The conveyance roller pair 16 is an example of a first conveyance roller pair provided upstream of a recording head 27 in the conveyance path 10.

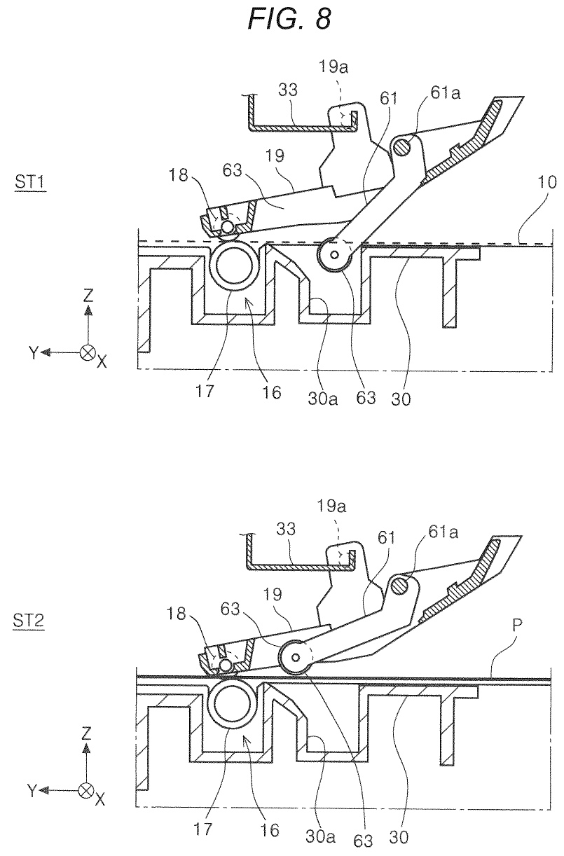

As illustrated in FIG. 8, the conveyance roller pair 16 includes a conveyance drive roller 17 that is rotationally driven and a conveyance driven roller 18 that nips the medium between the conveyance driven roller 18 and the conveyance drive roller 17. As illustrated in FIG. 8, the conveyance driven roller 18 is rotatably supported by a roller support member 19.

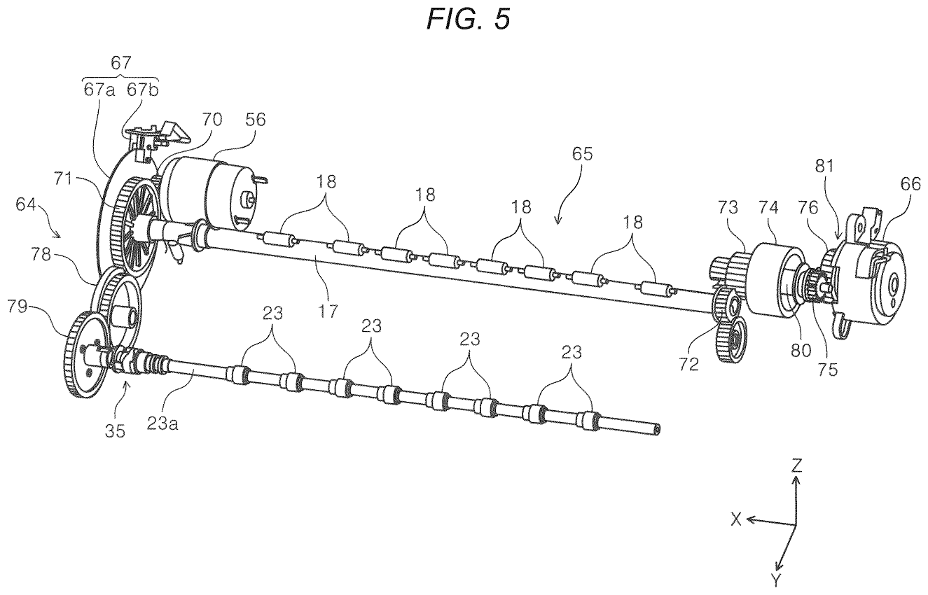

In the present embodiment, the conveyance drive roller 17 is a shaft extended in the X-axis direction as illustrated in FIG. 5. In the present embodiment, as illustrated in FIG. 5, a plurality of conveyance driven rollers 18 are provided at appropriate intervals in the X axis direction with respect to the conveyance drive roller 17.

In FIG. 8, the roller support member 19 is attached to a frame 33 via a swing shaft 19a and swings via the swing shaft 19a, whereby the conveyance driven roller 18 advances and retracts with respect to the conveyance drive roller 17. The roller support member 19 is pressed by a pressing member not illustrated in FIG. 8, for example, a torsion spring or an extension spring in a direction in which the conveyance driven roller 18 advances with respect to the conveyance drive roller 17.

Returning back to FIG. 2, a recording section 20 includes a carriage 26 and a recording head 27. The carriage 26 is configured to be capable of reciprocating in the X-axis direction. The recording head 27 is provided below the carriage 26. In the recording head 27, a plurality of ink ejection nozzles (not illustrated) capable of ejecting ink in the −Z direction are provided.

A facing section 30 that supports the medium is provided at a position that can face the recording head 27. The facing section 30 specifies the distance between the medium and the recording head 27. The recording head 27 ejects the ink to the medium supported by the facing section 30 to execute recording on a recording surface of the medium. The medium on which the recording has been executed is nipped by a discharge roller pair 22 disposed downstream of the recording head 27 in the conveyance path 10 and is discharged toward the medium receiving tray 6.

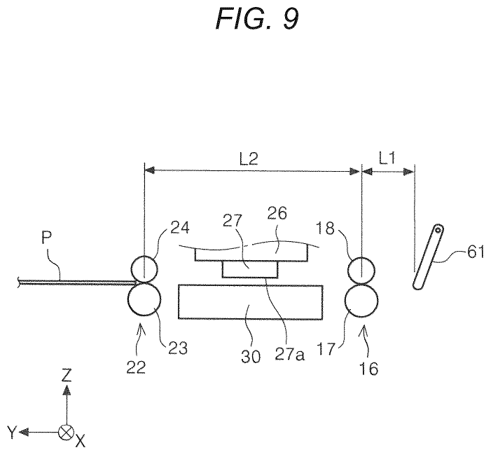

The discharge roller pair 22 is an example of a second roller pair that is provided downstream of the recording head 27 in the conveyance path 10 and conveys the medium. As illustrated in FIG. 9, the discharge roller pair 22 includes a discharge drive roller 23 that is rotationally driven and a discharge driven roller 24 that nips the medium between the discharge driven roller 24 and the discharge drive roller 23.

In the present embodiment, a plurality of pairs of the discharge drive roller 23 and the discharge driven roller 24 are provided at appropriate intervals in the X-axis direction. In the present embodiment, the discharge driven roller 24 is a toothed roller having teeth on the outer circumference thereof. The discharge driven roller 24 is capable of advancing and retracting with respect to the discharge drive roller 23 and nips the medium between the discharge driven roller 24 and the discharge drive roller 23 by using a not-illustrated bar spring as a rotary shaft.

In the present embodiment, a nip force for nipping the medium with the conveyance roller pair 16 is stronger than a nip force for nipping the medium with the discharge roller pair 22. Non-feeding of the medium in the conveyance roller pair 16 hardly occurs.

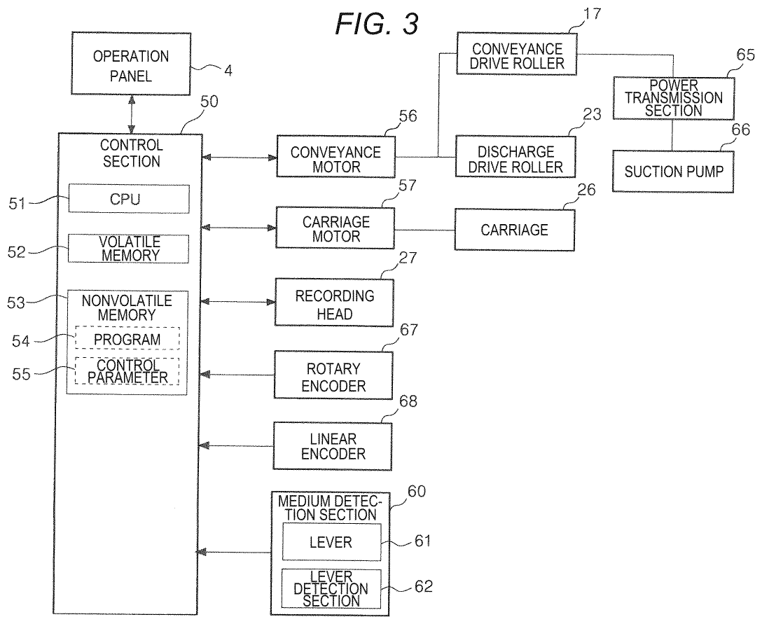

Next, a control system of the printer 1 is explained with reference to FIG. 3. In FIG. 3, only components necessary for the following explanation are illustrated and other components are not illustrated.

A control section 50 performs various kinds of control for the printer 1. The operation panel 4, a conveyance motor 56, a carriage motor 57, the recording head 27, a rotary encoder 67, a linear encoder 68, and a medium detection section 60 are connected to the control section 50.

The motors described above are, for example, DC motors. The control section 50 includes a driver circuit (not illustrated) for driving the motors.

The conveyance motor 56 is a common driving source for the conveyance drive roller 17, the discharge drive roller 23, and a suction pump 66. The suction pump 66 receives power from the conveyance motor 56 via a second power transmission section 65 explained later.

Hereinafter, a rotation direction of the conveyance motor 56 at the time when the medium is conveyed in the +Y direction, that is, downstream is referred to as forward rotation direction and the opposite direction of the forward rotation direction is referred to as reverse rotation direction. As explained in detail below, when the conveyance motor 56 rotates in the forward rotation direction, the conveyance drive roller 17 and the discharge drive roller 23 rotate forward, power is not transmitted to the suction pump 66, and the suction pump 66 does not operate. When the conveyance motor 56 rotates in the reverse rotation direction, the conveyance drive roller 17 and the discharge drive roller 23 reversely rotate, power is transmitted to the suction pump 66, and the suction pump 66 operates.

The carriage motor 57 is a driving source for the carriage 26.

The rotary encoder 67 detects the rotation of the conveyance drive roller 17. The control section 50 can detect the rotation direction, the rotation amount, and the rotation speed of the conveyance motor 56 based on an output signal of the rotary encoder 67.

The linear encoder 68 detects the position of the carriage 26. The control section 50 can detect the position and the moving speed of the carriage 26 based on an output signal of the linear encoder 68.

The medium detection section 60 detects passage of the leading end and the trailing end of the medium upstream of the conveyance roller pair 16 in the conveyance path 10.

The medium detection section 60 includes a lever 61 that swings in contact with the medium and a lever detection section 62 that detects the swing of the lever 61. As illustrated in FIG. 8, the lever 61 is provided to be capable of swinging with respect to the roller support member 19 via a swing shaft 61a. A driven roller 63 is provided at the tip of the lever 61 and frictional resistance at the time when the medium comes into contact with the lever 61 is reduced.

A recess 30a is provided in the facing section 30. In a state in which the lever 61 is not in contact with the medium, as indicated by a state ST1 in FIG. 8, the tip of the lever 61 enters the recess 30a and comes into contact with the edge in the −Y direction of the recess 30a to block the conveyance path 10. The lever 61 is pressed by a not-illustrated pressing member, for example, a torsion spring to maintain the state ST1 in FIG. 8.

The lever 61 is pushed up by the medium conveyed in the +Y direction, that is, from upstream to downstream and swings as indicated by a change from the state ST1 to a state ST2 in FIG. 8. Even when the medium conveyed in the −Y direction, that is, from downstream to upstream comes into contact with the lever 61, since the lever 61 comes into contact with the edge in the −Y direction of the recess 30a, the lever 61 cannot swing.

The lever detection section 62 (FIG. 3) can detect the swing, that is, the posture change of the lever 61. The control section 50 can detect the passage of the leading end and the trailing end of the medium based on a signal change of the lever detection section 62.

Returning back to FIG. 3, the control section 50 controls display of the operation panel 4, receives information transmitted from the operation panel 4, and performs various kinds of control.

The control section 50 includes a central processing Unit (CPU) 51 that performs execution processing of a computer program, in other words, software, a volatile memory 52, and a nonvolatile memory 53.

The CPU 51 performs various arithmetic operations necessary in executing programs 54 stored in the nonvolatile memory 53. The volatile memory 52 is used as a work area used by the CPU 51 when executing the programs 54 and a temporary data storage area. In the nonvolatile memory 53, the programs 54 and control parameters 55 necessary in executing the programs 54 are stored. The programs 54 include a program for executing various kinds of processing explained below. The control parameters 55 include parameters for executing the programs 54.

Various kinds of processing in the printer 1 are implemented by the control section 50 executing the programs 54.

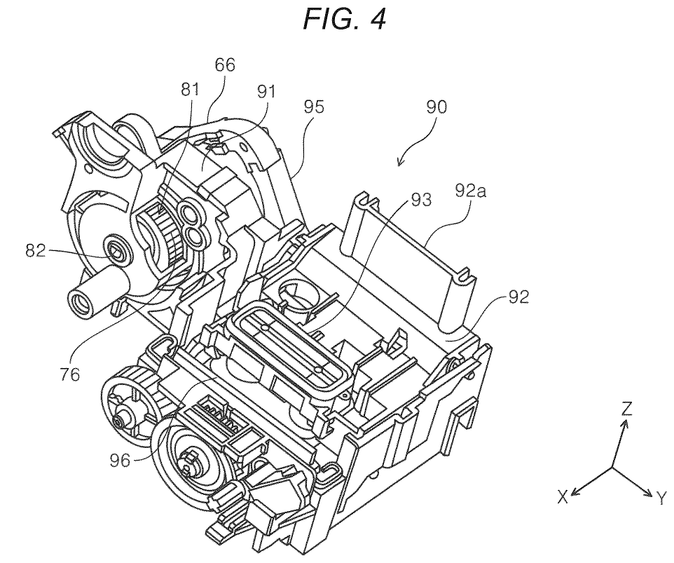

Next, a maintenance unit 90 including the suction pump 66 is explained with reference to FIGS. 4 to 7.

As illustrated in FIG. 4, the maintenance unit 90 includes a unit frame 91 as a base body. Elements such as the suction pump 66 and a slide base 92 are provided in the unit frame 91.

The slide base 92 is capable of sliding in the X-axis direction with respect to the unit frame 91 and is provided to be displaceable in the +Z direction as the slide base 92 slides in the −X direction. The slide base 92 is pressed in the +X direction by a not-illustrated spring.

A cap 93 is provided in the slide base 92.

The maintenance unit 90 is provided at the end portion in the −X direction inside the apparatus. When the carriage 26 moves to the end portion in the −X direction, the recording head 27 can face the cap 93.

An engaging section 92a is provided in the slide base 92. The carriage 26 is capable of coming into contact with the engaging section 92a. At a stage when the carriage 26 moves in the −X direction and comes into contact with the engaging section 92a, a gap is formed between a head surface 27a (see FIG. 9) of the recording head 27 and the cap 93. The position of the carriage 26 at this time is set as a cap facing position.

When the carriage 26 further moves in the −X direction from the cap facing position, the slide base 92 moves in the −X direction together with the carriage 26. Accordingly, the cap 93 rises and the cap 93 comes into close contact with the head surface 27a (see FIG. 9) of the recording head 27. The position of the carriage 26 at this time is set as a cap close contact position.

At a printing standby time, the carriage 26 is located at the cap close contact position. In processing of eliminating nozzle clogging of the recording head 27, the suction pump 66 is driven in a state in which the carriage 26 is located at the cap close contact position. The cap 93 and the suction pump 66 are connected by a tube 95 and a negative pressure is formed in the cap 93 by the operation of the suction pump 66.

At a flushing operation time, the ink is ejected from the recording head 27 to the cap 93 in a state in which the carriage 26 is located at the cap facing position. When the ink accumulates in the cap 93 accordingly, the suction pump 66 is driven to suck the ink in the cap 93.

The ink sucked by the suction pump 66 is sent to a not-illustrated waste ink storage section.

A wiper 96 is provided in the slide base 92. When the carriage 26 moves in the −X direction, the head surface 27a is wiped by the wiper 96.

A time lag mechanism 81 is provided in the unit frame 91. As explained in detail below, the time lag mechanism 81 configures a second power transmission section 65 (see FIG. 5) explained below. The time lag mechanism 81 is a mechanism that provides a time lag in power transmission after the rotation of the conveyance motor 56 is switched from the forward rotation direction to the reverse rotation direction. Accordingly, even when the rotation of the conveyance motor 56 is switched from the forward rotation direction to the reverse rotation direction, the suction pump 66 does not immediately operate and a time lag occurs until the suction pump 66 starts the operation.

FIG. 5 illustrates a first power transmission section 64 that transmits power from the conveyance motor 56 to the conveyance roller pair 16 and the discharge roller pair 22 and a second power transmission section 65 that transmits power from the conveyance motor 56 to the suction pump 66.

The conveyance motor 56 is provided near the end portion in the +X direction of the conveyance drive roller 17. A gear 70 is provided in a motor shaft of the conveyance motor 56 and power is transmitted from the gear 70 to a gear 71. The gear 71 is a gear provided at the end portion in the +X direction of the conveyance drive roller 17. A gear 78 meshes with the gear 71. The gear 78 meshes with a gear 79. The gear 79 is a gear provided at the +X direction end portion of a rotary shaft 23a of the discharge drive roller 23. With the configuration explained above, power is transmitted from the conveyance motor 56 to the conveyance drive roller 17 and the discharge drive roller 23. The gear 70, the gear 71, the gear 78, and the gear 79 configure the first power transmission section 64. Reference numeral 35 denotes a clutch provided between the gear 79 and the rotary shaft 23a. The clutch is explained again below.

A rotary scale 67a is provided in the gear 71. The rotary scale 67a enters a detection section 67b. The rotary scale 67a and the detection section 67b configure the rotary encoder 67.

A gear 72 is provided at the end portion in the −X direction of the conveyance drive roller 17 and power is transmitted from the gear 72 to a gear 73. The gear 73 and a gear 74 are integrally configured and power is transmitted from the gear 74 to the feeding roller 13 (see FIG. 2) via a not-illustrated gear.

A one-way clutch (not illustrated) is provided on the inside of the gear 74. With a function of the one-way clutch, power is transmitted from the gear 74 to a shaft 80 only when the conveyance motor 56 rotates in the reverse rotation direction. A one-way clutch may be provided on the inside of the suction pump 66.

A gear 75 is provided in the shaft 80. Power is transmitted from the gear 75 to a gear 76 configuring the time lag mechanism 81.

The gear 70, the gear 71, the conveyance drive roller 17, the gear 72, the gear 73, the gear 74, the shaft 80, the gear 75, and the time lag mechanism 81 configure the second power transmission section 65.

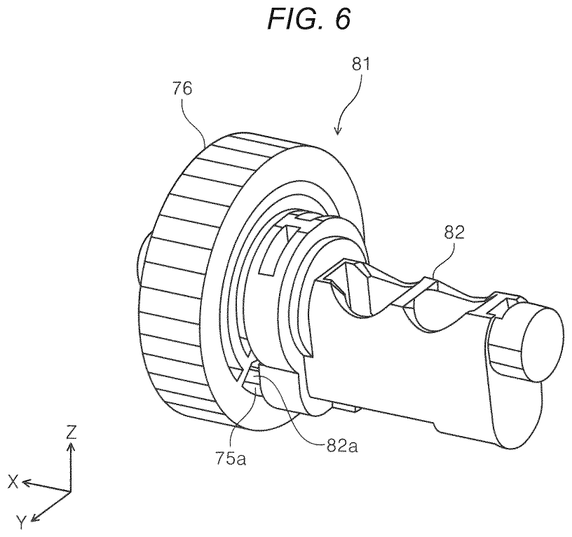

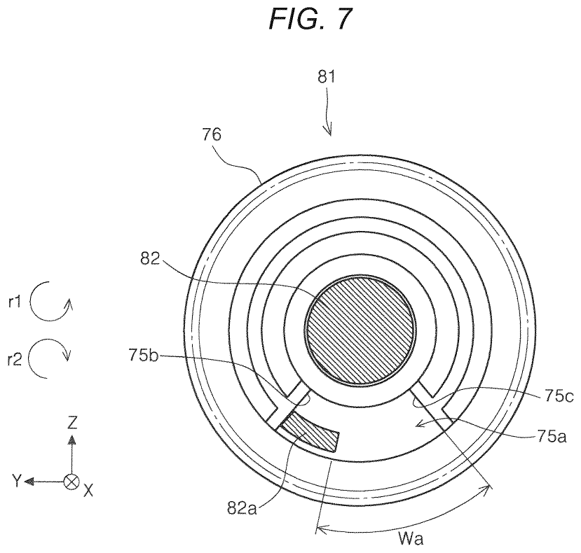

As illustrated in FIG. 6, the time lag mechanism 81 includes the gear 76 and a transmission shaft 82 that transmits power to the suction pump 66. As illustrated in FIG. 7 as well, a groove 75a extending in the circumferential direction is formed in the gear 76. A boss section 82a is formed in the transmission shaft 82. The boss section 82a enters the groove 75a. A first inner wall 75b and a second inner wall 75c are formed on the inner side of the groove 75a.

In FIG. 7, a rotation direction r1 is a rotation direction of the gear 76 at the time when the conveyance motor 56 rotates in the forward rotation direction. When the conveyance motor 56 rotates in the forward rotation direction, the gear 76 rotates in the rotation direction r1. Accordingly, the boss section 82a comes into contact with the first inner wall 75b of the groove 75a and the transmission shaft 82 rotates in the rotation direction r1.

When the conveyance motor 56 rotates in the reverse rotation direction from this state, the gear 76 rotates in a rotation direction r2. However, power is not transmitted to the transmission shaft 82 until the boss section 82a comes into contact with the second inner wall 75c of the groove 75a. Accordingly, the time lag explained above occurs. In FIG. 7, reference sign Wa denotes a rotation amount of the gear 76 until the boss section 82a comes into contact with the second inner wall 75c of the groove 75a.

Next, a jam that occurs when the conveyance motor 56 rotates in the reverse rotation direction is explained.

When determining that it is cap suction timing, the control section 50 causes the suction pump 66 to operate. Here, the cap suction is processing of sucking the ink accumulated in the cap 93 (see FIG. 4) by a flushing operation. The control section 50 grasps a total amount of ink ejected to the cap 93 by the flushing operation and performs the cap suction when the total amount exceeds a predetermined value. The cap suction is performed, for example, at the end of a print job but is not limited thereto and may be performed when power is turned off.

Here, when the suction pump 66 is caused to operate when the trailing end of a discharged medium is located near the discharge roller pair 22 as illustrated in FIG. 9 or when a part of the discharged medium remains in the conveyance path 10, the medium is sometimes sent in the upstream direction of the conveyance path 10. This is because it is necessary to rotate the conveyance motor 56 in the reverse rotation direction in order to cause the suction pump 66 to operate. As a result, it is likely that a jam occurs. In particular, upstream of the conveyance roller pair 16 is a deep position of the apparatus. When the medium conveyed in the upstream direction is nipped again by the conveyance roller pair 16 and is further sent upstream and a jam occurs, it is likely that jam processing is difficult. As explained with reference to FIG. 8, the lever 61 configuring the medium detection section 60 does not swing even if the medium conveyed upstream comes into contact with the lever 61. For this reason, when the medium conveyed in the upstream direction is nipped again by the conveyance roller pair 16 and further sent upstream, it is highly likely that a jam occurs.

In FIG. 9, a distance L1 is a path length between the conveyance roller pair 16 and the lever 61 and a distance L2 is a path length between the conveyance roller pair 16 and the discharge roller pair 22. The distance L1 is shorter than the distance L2.

Hereinafter, a clutch 35 for suppressing the jam explained above is explained.

The clutch 35 illustrated in FIG. 5 transmits the power of the conveyance motor 56 to the rotary shaft 23a, that is, the discharge drive roller 23 when the conveyance motor 56 rotates in the forward rotation direction. The clutch 35 does not transmit the power of the conveyance motor 56 to the rotary shaft 23a, that is, the discharge drive roller 23, that is, blocks the power when the conveyance motor 56 rotates in the reverse rotation direction.

With the clutch 35 explained above, the discharge drive roller 23, that is, the discharge roller pair 22 does not rotate when the conveyance motor 56 rotates in the reverse rotation direction. For this reason, when the conveyance motor 56 is rotated in the reverse rotation direction, it is possible to prevent the medium from being sent upstream of the conveyance path 10 and it is possible to suppress the occurrence of the jam explained above.

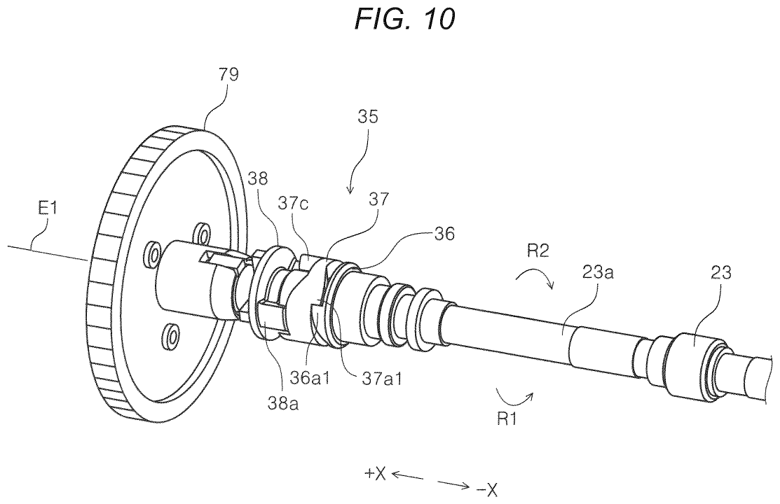

Hereinafter, a configuration of the clutch 35 is explained with reference to FIG. 10 and the subsequent figures.

Hereinafter, configurations, rotation directions, and the like of members are explained using terms “circumferential direction R1”, “circumferential direction R2”, “+X direction”, and “−X direction”. The directions are illustrated in the figures. The term “circumferential direction” is sometimes referred to as a “rotation direction”.

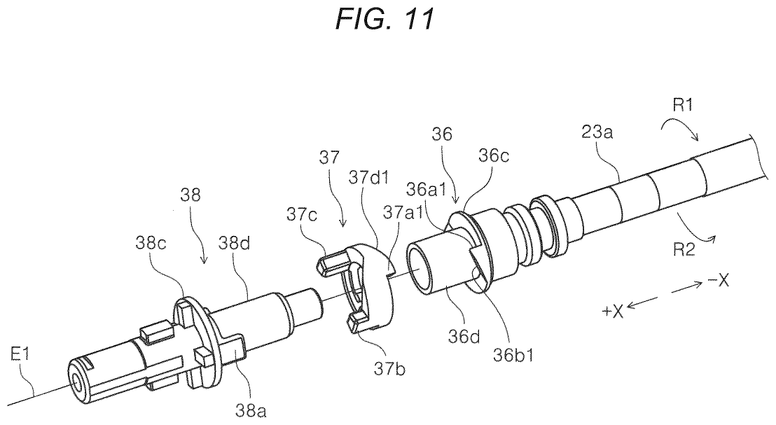

As illustrated in FIGS. 10 and 11, the clutch 35 includes a first gear 36, a second gear 37, and a third gear 38. The first gear 36, the second gear 37, and the third gear 38 are disposed along a rotation axis E1 of the discharge drive roller 23.

The first gear 36 is provided at the +X direction end portion of the rotary shaft 23a and formed integrally with the rotary shaft 23a in the present embodiment. That is, the first gear 36 is a gear that rotates together with the discharge drive roller 23.

The third gear 38 engages with the gear 79 to rotate integrally with the gear 79. The third gear 38 is a gear to which power is transmitted from the first power transmission section 64 and is a gear that transmits the power to the second gear 37 explained below.

The second gear 37 is a gear sandwiched by the first gear 36 and the third gear 38. The second gear 37 is a gear that meshes with the first gear 36 when the conveyance motor 56 rotates in the forward rotation direction and does not mesh with the first gear 36 when the conveyance motor 56 rotates in the reverse rotation direction.

This is further explained below.

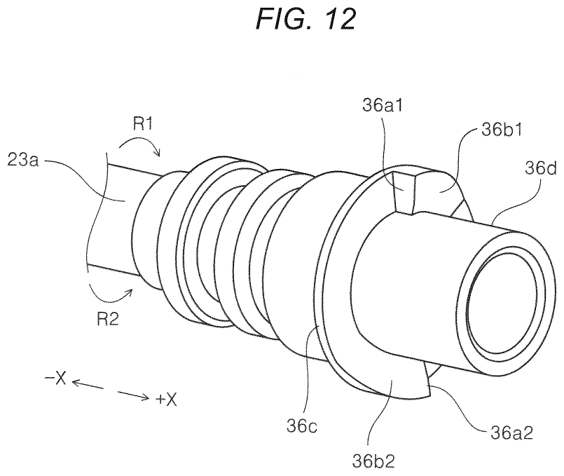

As illustrated in FIG. 12, the first gear 36 includes a flange-shaped base section 36c, two first teeth 36a, two first inclined surfaces 36b, and a cylindrical section 36d. One of the two first teeth 36a is denoted by reference sign 36a1 and the other is denoted by reference sign 36a2. When the two first teeth 36a are not distinguished, the two first teeth 36a are collectively referred to as “first teeth 36a” below. Similarly, one of the two first inclined surfaces 36b is denoted by reference sign 36b1 and the other is denoted by reference sign 36b2. When the two first inclined surfaces 36b are not distinguished, the two first inclined surfaces 36b are collectively referred to as “first inclined surfaces 36b” below.

The first teeth 36a are formed to protrude in the +X direction from the base section 36c and are formed to be able to mesh with second teeth 37a of the second gear 37 explained below when the second teeth 37a rotate in the circumferential direction R1.

The first inclined surfaces 36b are formed on the first teeth 36a. The first inclined surfaces 36b are surfaces inclined such that a tooth height decreases in the circumferential direction R1. Here, the tooth height may be replaced with a protrusion amount of protrusion from the base section 36c in the +X direction.

In the present embodiment, the two first teeth 36a, that is, the first tooth 36a1 and the first tooth 36a2 are provided such that a disposition interval in the circumferential direction is 180°. Similarly, the two first inclined surfaces 36 b, that is, the first inclined surface 36b1 and the first inclined surface 36b2 are provided such that a disposition interval in the circumferential direction is 180°.

The cylindrical section 36d is formed to be smaller in diameter than the base 36c and protrude further in the +X direction than the base section 36c.

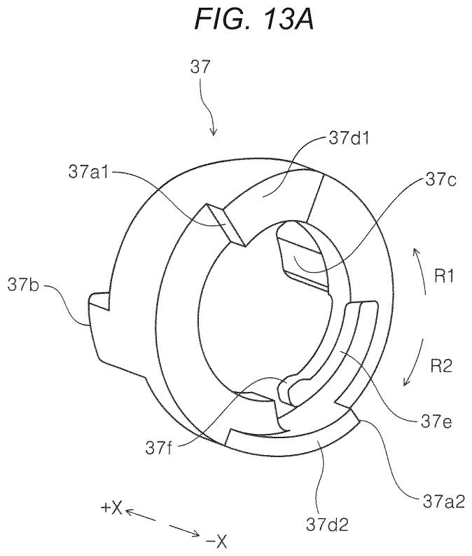

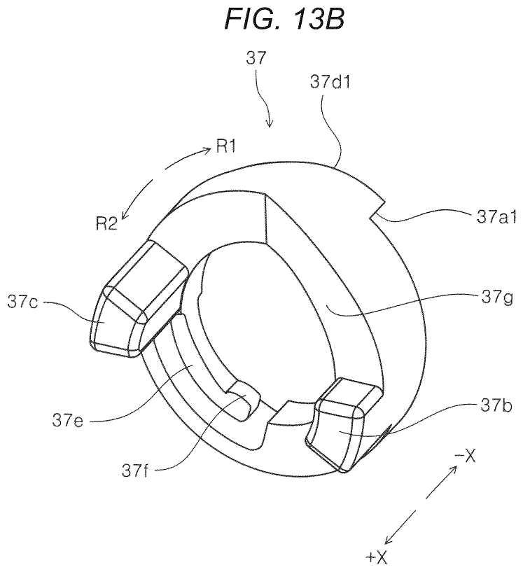

The second gear 37 is formed in a ring shape as a whole as illustrated in FIGS. 13A and 13B and fits to the cylindrical section 36d of the first gear 36 explained above and is rotatable relatively to the cylindrical section 36d.

An elastic deformation section 37e is formed in the inner circumferential section of the second gear 37 in the circumferential direction. The elastic deformation section 37e is formed to have a cantilever structure and is elastically deformable in the radial direction. A pressing section 37f is formed at the tip of the elastic deformation section 37e to protrude toward the radial direction inner side. When the second gear 37 fits to the cylindrical section 36d of the first gear 36, the pressing section 37f can come into press contact with the outer circumferential surface of the cylindrical section 36d. Accordingly, the second gear 37 can fit to the cylindrical section 36d without rattling.

Two second teeth 37a and two second inclined surfaces 37d are formed on a surface in the −X direction, that is, a surface facing the first gear 36 in the second gear 37. One of the two second teeth 37a is denoted by reference sign 37a1 and the other is denoted by reference sign 37a2. When the two second teeth 37a are not distinguished, the two second teeth 37a are collectively referred to as “second teeth 37a” below. Similarly, one of the two second inclined surfaces 37d is denoted by reference sign 37d1 and the other is denoted by reference sign 37d2. When the two second inclined surfaces 37d are not distinguished, the two second inclined surfaces 37d are collectively referred to as “second inclined surfaces 37d” below.

The second teeth 37a are formed to protrude in the −X direction and can mesh with the first teeth 36a of the first gear 36 when the second gear 37 rotates in the circumferential direction R1.

The second inclined surfaces 37d are formed on the second teeth 37a. The second inclined surfaces 37d are surfaces inclined such that a tooth height decreases in the circumferential direction R2. Here, the tooth height may be replaced with a protrusion amount of protrusion in the −X direction.

One third tooth 37b and one fourth tooth 37c are formed on a surface in the +X direction, that is, a surface facing the third gear 38 in the second gear 37. In the present embodiment, the third tooth 37b and the fourth tooth 37c are provided such that a disposition interval in the circumferential direction is 180°.

A third inclined surface 37g is formed between the third tooth 37b and the fourth tooth 37c to face the +X direction in the circumferential direction R1.

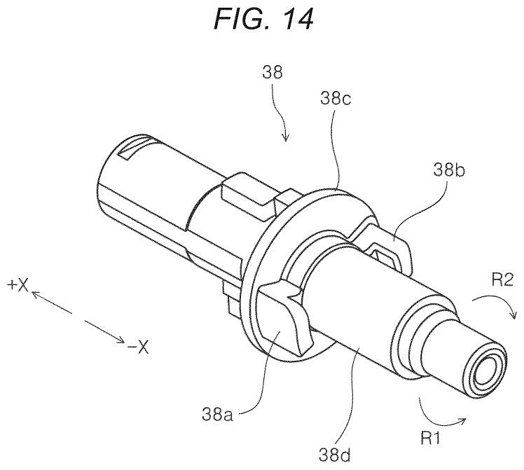

As illustrated in FIG. 14, the third gear 38 includes a flange section 38c, a fifth tooth 38a, a sixth tooth 38b, and a columnar section 38d.

The fifth tooth 38a and the sixth tooth 38b are formed to protrude in the −X direction from the flange section 38c. In the present embodiment, the fifth tooth 38a and the sixth tooth 38b are provided such that a disposition interval in the circumferential direction is 180°.

The columnar section 38d can fit to the cylindrical section 36d of the first gear 36 in a state of having play. In other words, the columnar section 38d can fit to be capable of rotating relatively to the cylindrical section 36d of the first gear 36.

An operation of the clutch 35 configured as explained above is explained.

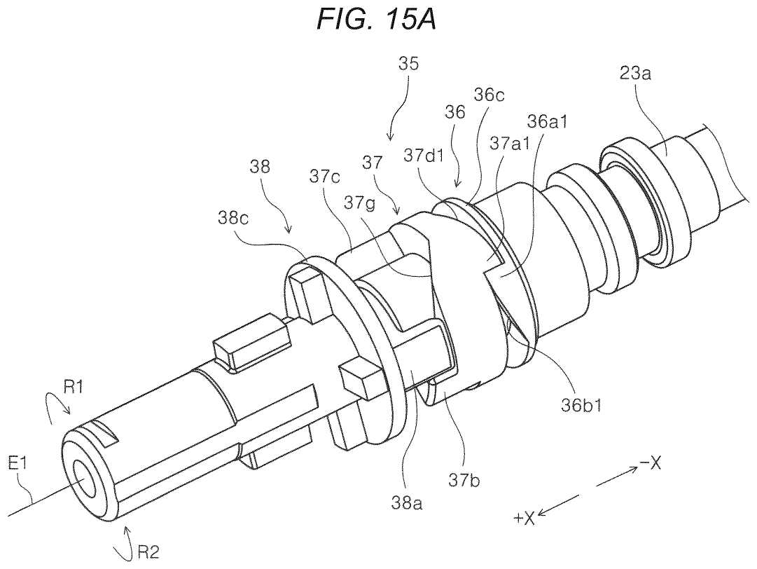

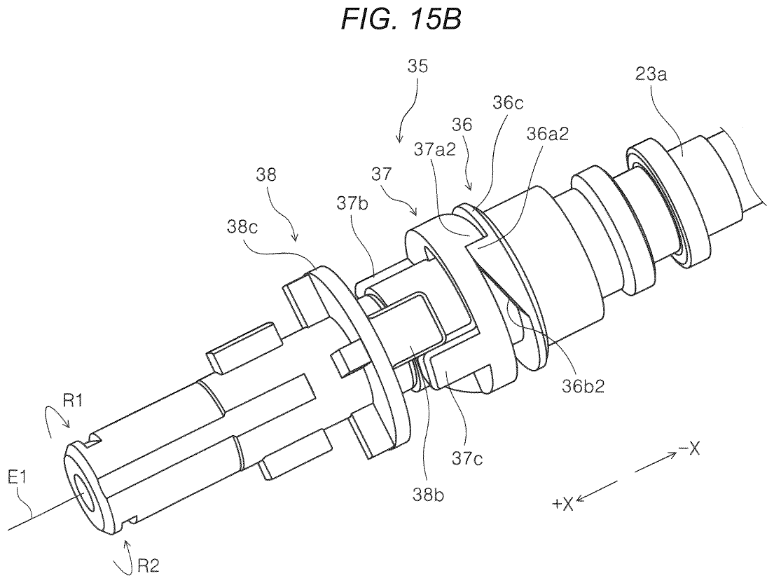

FIGS. 10, 15A, and 15B illustrate a power transmission state of the clutch 35. FIG. 15B is a diagram viewed from a visual point different from that in FIG. 15A.

The clutch 35 transmits rotation of the third gear 38 in the circumferential direction R1 to the first gear 36 via the second gear 37 in the power transmission state. When the conveyance motor 56 rotates in the forward rotation direction, the third gear 38 rotates in the circumferential direction R1.

In the power transmission state of the clutch 35, the fifth tooth 38a of the third gear 38 meshes with the third tooth 37b of the second gear 37 to rotate the second gear 37 in the circumferential direction R1. In this case, the second teeth 37a of the second gear 37 mesh with the first teeth 36a of the first gear 36 to rotate the first gear 36 in the circumferential direction R1.

In this state, as illustrated in FIG. 15A, the fifth tooth 38a of the third gear 38 restricts displacement of the second gear 37 in the +X direction. This is because the interval between the fifth tooth 38a and the second gear 37 is reduced by the third inclined surface 37g. Accordingly, the second teeth 37a is restricted from separating from the first teeth 36a in the +X direction and a state in which the second teeth 37a and the first teeth 36a mesh with each other is maintained.

In this state, the first tooth 36a1 and the second tooth 37a1 mesh with each other, and the first tooth 36a2 and the second tooth 37a2 mesh with each other.

In this state, as illustrated in FIG. 15B, the sixth tooth 38b and the fourth tooth 37c mesh with each other.

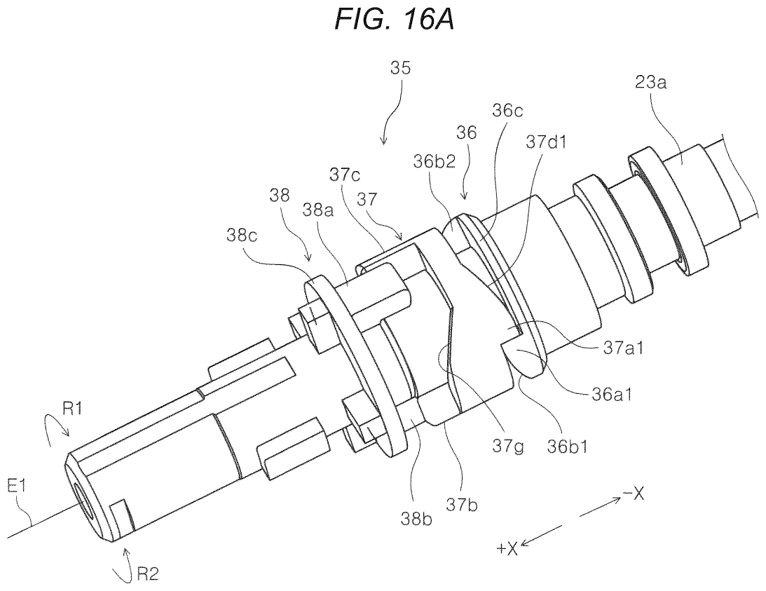

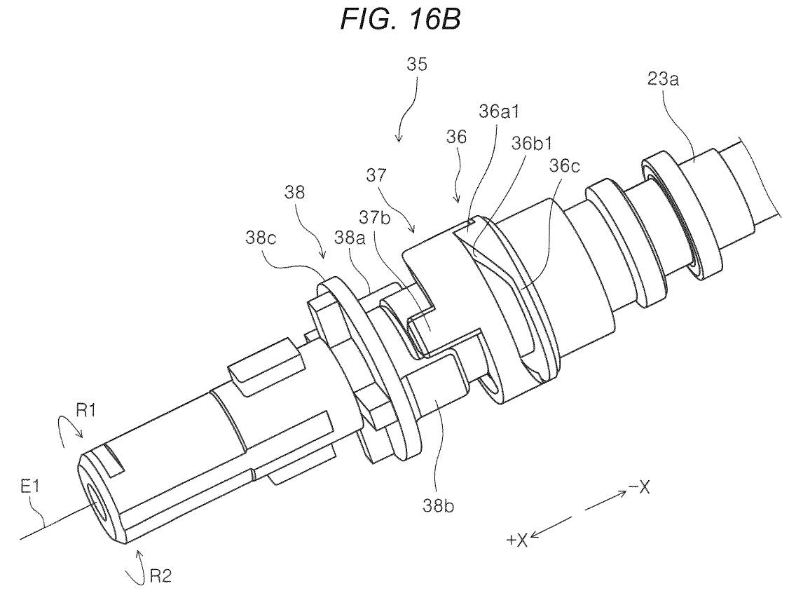

When the third gear 38 rotates in the circumferential direction R2 according to the rotation of the conveyance motor 56 in the reverse rotation direction from this state, first, as illustrated in FIG. 16A, the fifth tooth 38a of the third gear 38 separates from the third tooth 37b of the second gear 37. Then, the fifth tooth 38a of the third gear 38 meshes with the fourth tooth 37c of the second gear 37. The sixth tooth 38b of the third gear 38 separates from the fourth tooth 37c of the second gear 37 and meshes with the third tooth 37b of the second gear 37 as illustrated in FIG. 16B.

In this state, an interval in the X-axis direction is formed between the fifth tooth 38a and the second gear 37 (see FIG. 16A) and an interval in the X-axis direction is also formed between the sixth tooth 38b and the second gear 37 (see FIG. 16B). This is because the interval between the fifth tooth 38a and the second gear 37 is increased by the third inclined surface 37g. Accordingly, the second gear 37 is allowed to move in the +X direction.

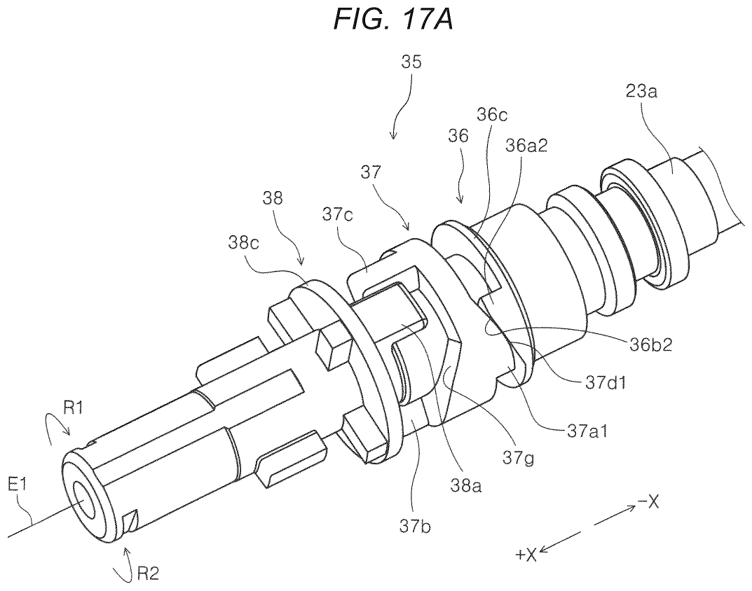

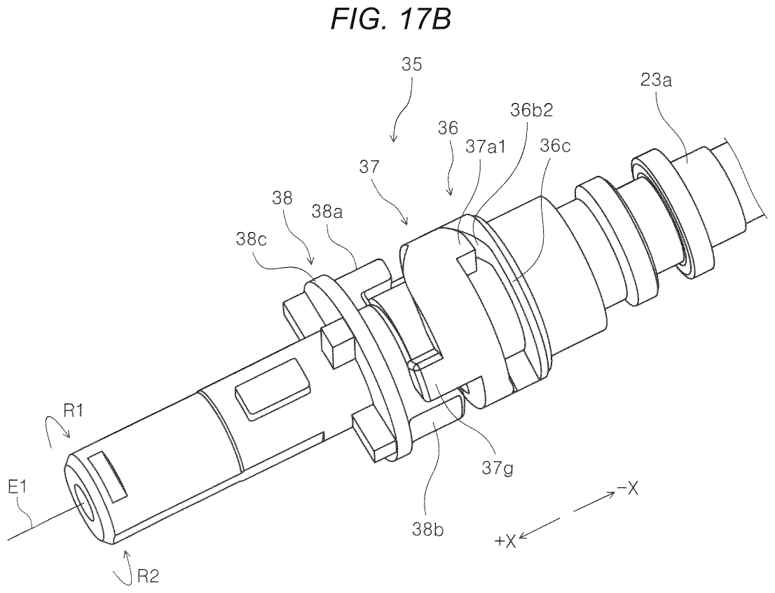

When the third gear 38 further rotates in the circumferential direction R2 from this state, the second gear 37 rotates in the circumferential direction R2 and the second teeth 37a separate from the first teeth 36a. As illustrated in FIGS. 17A and 17B, the second inclined surface 37d of the second gear 37 comes into contact with the first inclined surface 36b of the first gear 36, whereby the second gear 37 moves in the +X direction.

When the second gear 37 moves in the +X direction as explained above, since the second teeth 37a and the first teeth 36a do not mesh with each other, the second gear 37 changes to a state of not transmitting power to the first gear 36, that is, a power cut state of the clutch 35.

When the conveyance motor 56 rotates in the forward rotation direction from the power cut state, the gears transition in order opposite to the order explained above. As a result, as illustrated in FIGS. 15A and 15B, the second teeth 37a of the second gear 37 and the first teeth 36a of the first gear 36 mesh with each other again and the second gear 37 changes to a state of transmitting power to the first gear 36.

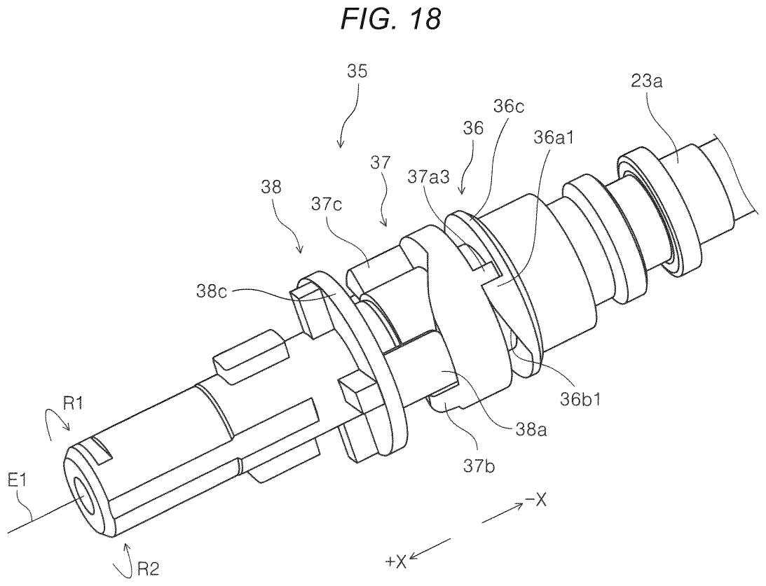

The second inclined surface 37d of the second gear 37 may be omitted as illustrated in FIG. 18. A second tooth 37a3 illustrated in FIG. 18 does not include the second inclined surface 37d. Even in such a configuration, since the first inclined surface 36b is formed on the first gear 36, the second tooth 37a3 can slide on the first inclined surface 36b and thus the meshing between the second gear 37 and the first gear 36 can be released.

As explained above, the first gear 36, the second gear 37, and the third gear 38 are disposed along the rotation axis E1 of the discharge drive roller 23. The first gear 36 includes the first teeth 36a protruding toward the second gear 37. The second gear 37 includes the second teeth 37a protruding toward the first gear 36. The second teeth 37a mesh with the first teeth 36a when the conveyance motor 56 rotates in the forward rotation direction (see FIGS. 15A and 15B). The second teeth 37a do not mesh with the first teeth 36a when the conveyance motor 56 rotates in the reverse rotation direction (see FIGS. 17A and 17B).

As explained above, the clutch 35 can be configured with a simple structure by the first gear 36, the second gear 37, and the third gear 38. Since the first gear 36, the second gear 37, and the third gear 38 are disposed along the rotation axis E1 of the discharge drive roller 23, it is possible to prevent the clutch 35 from increasing in size in the radial direction of the discharge drive roller 23.

In the first gear 36, the first inclined surface 36b inclined in a direction in which the tooth height decreases from the first teeth 36a is formed. The second teeth 37a slide on the first inclined surface 36b when the conveyance motor 56 rotates in the reverse rotation direction (see FIGS. 17A and 17B).

With the configuration explained above, it is possible to easily obtain a configuration in which the second teeth 37a do not mesh with the first teeth 36a when the conveyance motor 56 rotates in the reverse rotation direction.

The second gear 37 includes the third tooth 37b and the fourth tooth 37c protruding toward the third gear 38. The third tooth 37b and the fourth tooth 37c are provided at an interval in the rotation direction. The third gear 38 includes the fifth tooth 38a protruding toward the second gear 37.

The fifth tooth 38a meshes with the third tooth 37b when the conveyance motor 56 rotates in the forward rotation direction (see FIG. 15A) and meshes with the fourth tooth 37c when the conveyance motor 56 rotates in the reverse rotation direction (see FIG. 17A).

When the fifth tooth 38a meshes with the third tooth 37b, movement of the second gear 37 along the rotation axis is restricted between the first gear 36 and the third gear 38. Accordingly, a state in which the first teeth 36a and the second teeth 37a mesh with each other is maintained (see FIG. 15A).

When the fifth tooth 38a meshes with the fourth tooth 37c, movement of the second gear 37 along the rotation axis E1 is allowed between the first gear 36 and the third gear 38, whereby the second teeth 37a slide on the first inclined surface 36b (see FIG. 17A).

With such a configuration, it is possible to implement a configuration in which the second teeth 37a slide on the first inclined surface 36b when the conveyance motor 56 rotates in the reverse rotation direction.

Since the fifth tooth 38a meshes with the fourth tooth 37c when the conveyance motor 56 rotates in the reverse rotation direction, the fifth tooth 38a can quickly mesh with the third tooth 37b when the conveyance motor 56 rotates in the forward rotation direction from this state.

However, when it is unnecessary to quickly mesh the fifth tooth 38a because a time lag is desired to be provided, the fourth tooth 37c can also be omitted.

In the present embodiment, the sixth tooth 38b provided in the third gear 38 meshes with the fourth tooth 37c when the conveyance motor 56 rotates in the forward rotation direction (see FIG. 15B). The sixth tooth 38b meshes with the third tooth 37b when the conveyance motor 56 rotates in the reverse rotation direction (see FIG. 17B).

Therefore, when the conveyance motor 56 rotates in the forward rotation direction, the fifth tooth 38a meshes with the third tooth 37b and the sixth tooth 38b meshes with the fourth tooth 37c. Here, if the sixth tooth 38b is not provided and only the fifth tooth 38a and the third tooth 37b mesh with each other in the rotation direction, it is likely that, since the second gear 37 tilts with respect to the rotation axis E1, frictional resistance increases and movement of the second gear 37 becomes stiff.

However, as explained above, when the conveyance motor 56 rotates in the forward rotation direction, the fifth tooth 38a meshes with the third tooth 37b and the sixth tooth 38b meshes with the fourth tooth 37c. For this reason, it is possible to suppress the increase in the frictional resistance due to the tilt of the second gear 37 and it is possible to prevent the movement of the second gear 37 from becoming stiff.

The same applies when the conveyance motor 56 rotates in the reverse rotation direction. When the conveyance motor 56 rotates in the reverse rotation direction, the fifth tooth 38a meshes with the fourth tooth 37c and the sixth tooth 38b meshes with the third tooth 37b. For this reason, it is possible to suppress the increase in the frictional resistance due to the tilt of the second gear 37 with respect to the rotation axis E1 and it is possible to prevent the movement of the second gear 37 from becoming stiff.

However, when the length of the second gear 37 in the rotation axis direction can be sufficiently secured, the sixth tooth 38b can also be omitted.

In the present embodiment, the plurality of first teeth 36a are provided at intervals in the rotation direction in the first gear 36. Specifically, in the present embodiment, the first teeth 36a1 and 36a2 are provided in the first gear 36.

Here, if there is only one first tooth 36a, it is likely that it takes time for the second teeth 37a to mesh with the first tooth 36a when the conveyance motor 56 switches the rotation from the reverse rotation direction to the forward rotation direction.

However, with the configuration in which the plurality of the first teeth 36a are provided at intervals in the rotation direction, the second teeth 37a can quickly mesh with the first teeth 36a when the conveyance motor 56 switches the rotation from the reverse rotation direction to the forward rotation direction.

However, only one first tooth 36a may be provided.

In the present embodiment, the plurality of second teeth 37a are provided at intervals in the rotation direction in the second gear 37.

Here, if the second gear 37 includes only one second tooth 37a, it is likely that, since the second gear 37 tilts with respect to the rotation axis E1, frictional resistance increases and the movement of the second gear 37 becomes stiff.

However, with the configuration in which the plurality of second teeth 37a are provided at intervals in the rotation direction, it is possible to suppress the increase in the frictional resistance due to the tilt of the second gear 37 with respect to the rotation axis E1 and it is possible to prevent the movement of the second gear 37 from becoming stiff.

However, only one second tooth 37a may be provided.

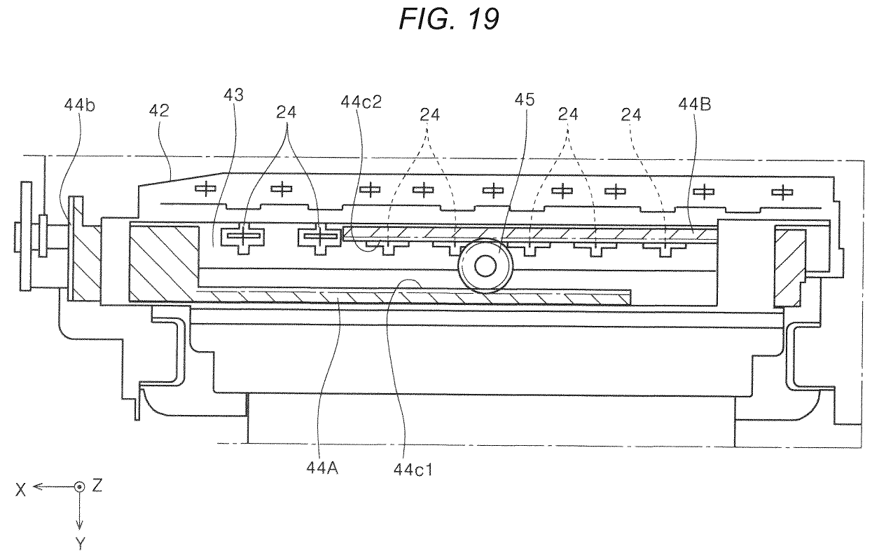

Next, another means for suppressing a jam that occurs when the conveyance motor 56 rotates in the reverse rotation direction is explained with reference to FIG. 19 and subsequent drawings. The means explained below may be adopted instead of the clutch 35 explained above or may be adopted in addition to the clutch 35.

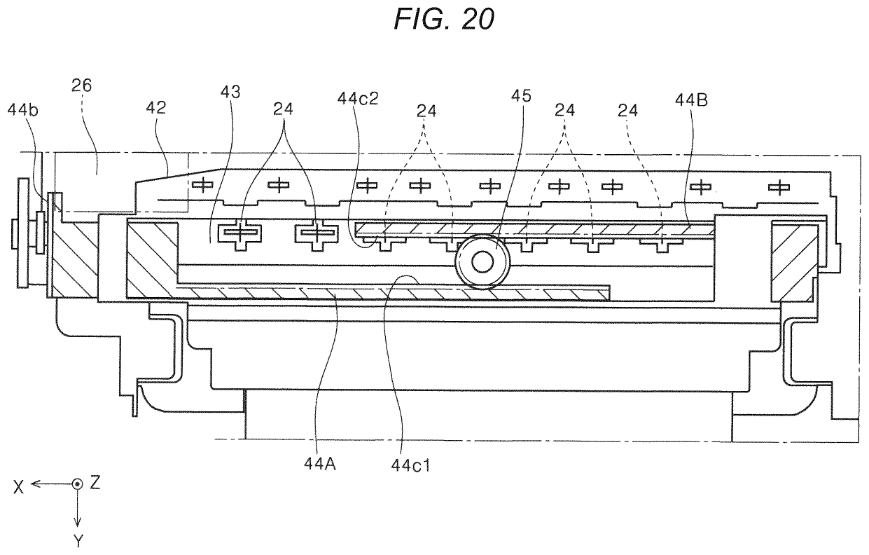

In FIGS. 19 and 20, reference numeral 42 denotes a fixed frame and reference numeral 43 denotes a movable frame. The movable frame 43 is provided to be displaceable in the Z-axis direction with respect to the fixed frame 42. The movable frame 43 rotatably supports a plurality of discharge driven rollers 24 in the X-axis direction, that is, the medium width direction.

In FIGS. 19 and 20, reference signs 44A and 44B denote slide members. In FIGS. 19 and 20, the slide members 44A and 44B are hatched for convenience of illustration.

The slide members 44A and 44B are provided to be capable of sliding in the medium width direction in the fixed frame 42. In both of the slide members 44A and 44B, rack sections configuring a rack and pinion mechanism are formed on facing sides. The rack section of the slide member 44A is denoted by reference sign 44c1 and the rack section of the slide member 44B is denoted by reference sign 44c2.

A pinion 45 configuring a rack and pinion mechanism is rotatably provided between the slide members 44A and 44B. The pinion 45 meshes with the rack section 44c1 of the slide member 44A and meshes with the rack section 44c2 of the slide member 44B. Accordingly, when the slide member 44A moves in the +X direction, the slide member 44B moves in the-X direction and, when the slide member 44A moves in the −X direction, the slide member 44B moves in the +X direction.

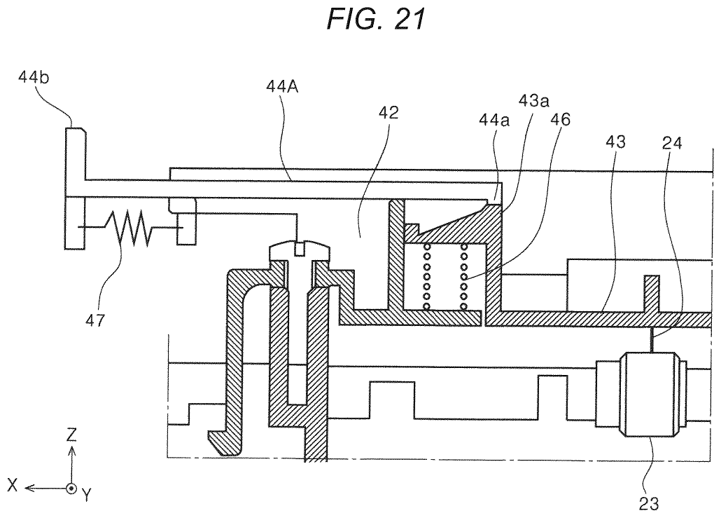

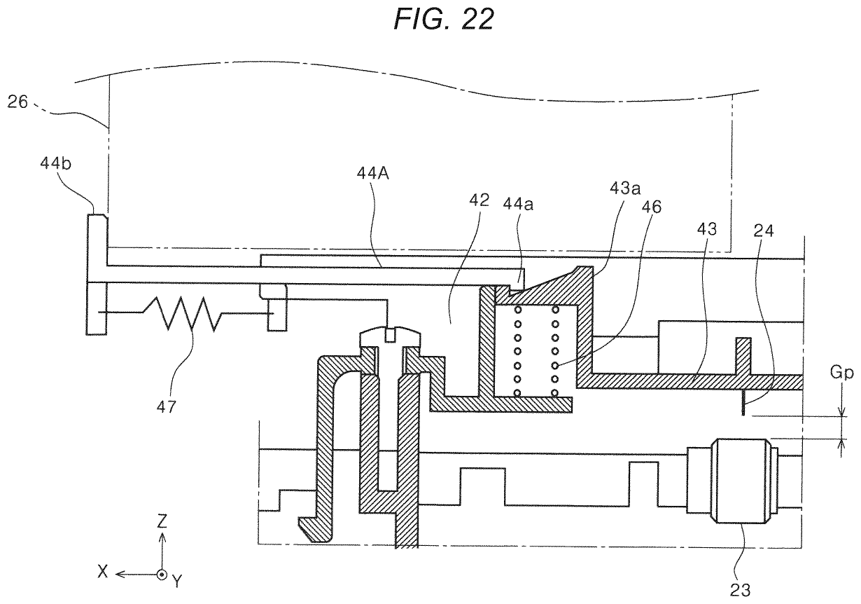

FIGS. 21 and 22 illustrate a relationship between the slide member 44A and the movable frame 43. A relationship between the slide member 44B and the movable frame 43 is the same. Although not illustrated, specifically, the relationship is symmetrical to the structure illustrated in FIGS. 21 and 22.

In FIG. 21, the slide member 44A is pulled in the −X direction by an extension spring 47. Therefore, when no external force is applied to the slide member 44A, a state illustrated in FIG. 21 is maintained.

The slide member 44A includes a restricting section 44a and the movable frame 43 includes a restricted section 43a. The movable frame 43 is pressed in the +Z direction by a compression coil spring 46, which is an example of a pressing member. In the state illustrated in FIG. 21, the restricting section 44a of the slide member 44A is located above the restricted section 43a of the movable frame 43 and restricts displacement of the movable frame 43 in the +Z direction. When the position of the movable frame 43 in this state is a first position and the movable frame 43 is present at the first position, the discharge driven roller 24 can nip the medium between the discharge driven roller 24 and the discharge drive roller 23.

The slide member 44A includes a carriage engaging section 44b capable of engaging with the carriage 26. A carriage engaging section capable of engaging with the carriage 26 is not formed in the slide member 44B.

When the carriage 26 moves out of a printing region in the +X direction, the carriage 26 can press the carriage engaging section 44b in the +X direction as illustrated in FIGS. 20 and 22. Accordingly, the slide member 44A slides in the +X direction, a restricted state of the restricted section 43a by the restricting section 44a is released, and the movable frame 43 is displaced in the +Z direction by a spring force of the compression coil spring 46. When the position of the movable frame 43 in this state is a second position and the movable frame 43 is present at the second position, the discharge driven roller 24 separates from the discharge drive roller 23. In FIG. 22, reference sign Gp denotes an interval between the discharge drive roller 23 and the discharge driven roller 24.

When the slide member 44A slides in the +X direction, the slide member 44B is displaced in the-X direction by the rack and pinion mechanism explained above as indicated by a change from FIG. 19 to FIG. 20.

Therefore, the slide member 44B also changes to a state of allowing displacement of the movable frame 43 in the +Z direction.

When the carriage 26 moves in the −X direction from this state, the slide member 44A slides in the −X direction with a spring force of the extension spring 47. At this time, the slide member 44B slides in the +X direction with the rack and pinion mechanism explained above. Accordingly, the movable frame 43 is displaced from the second position to the first position.

Based on the configuration explained above, the control section 50 disposes the movable frame 43 at the first position when rotating the conveyance motor 56 in the forward rotation direction and disposes the movable frame 43 at the second position when rotating the conveyance motor 56 in the reverse rotation direction.

Accordingly, even when the conveyance motor 56 rotates in the reverse rotation direction and the discharge drive roller 23 reversely rotates, it is possible to prevent the medium from being sent upstream of the conveyance path 10 and it is possible to suppress occurrence of a jam.

When the slide members 44A and 44B do not receive an external force from the carriage 26, the slide members 44A and 44B hold the movable frame 43 at the first position against a pressing force of the compression coil spring 46. The slide members 44A and 44B receive an external force from the carriage 26 and move in the width direction to allow displacement of the movable frame 43 toward the second position.

With configuration explained above, since the movable frame 43 is displaced to the first position and the second position by the operation of the carriage 26, a dedicated power source for displacing the movable frame 43 is unnecessary and it is possible to suppress an increase in cost of the apparatus.

When the carriage 26 separates from the slide member 44A, the movable frame 43 is displaced from the second position to the first position. For this reason, when the conveyance motor 56 is rotated in the reverse rotation direction in order to cause the suction pump 66 to operate in a state in which the carriage 26 is located at the home position, it is likely that the medium is sent upstream of the conveyance path 10.

Therefore, when the movable frame 43 is held at the second position regardless of the position of the carriage 26, for example, it is suitable to engage the slide member 44A with a not-illustrated push latch mechanism. In this case, when the carriage 26 moves the slide member 44A in the +X direction while the movable frame 43 is located at the first position, a state illustrated in FIG. 22, that is, a state in which the movable frame 43 is located at the second position is retained by the push latch mechanism. When the carriage 26 moves the slide member 44A in the +X direction in this state, the state illustrated in FIG. 22, that is, the state in which the movable frame 43 is held at the second position is released by the push latch mechanism and the movable frame 43 is displaced to the first position.

The movable frame 43 may be configured to be displaced to the first position and the second position by a dedicated actuator such as a solenoid. In this case, the position of the movable frame 43 can be freely switched by the control of the control section 50 regardless of the position of the carriage 26.

The present disclosure is not limited to the embodiment and the modifications explained above and various modifications can be made within the scope of the disclosure set forth in the appended claims, and it is needless to say that these modifications also fall within the scope of the disclosure.

For example, the clutch 35 explained above may be a one-way clutch having another structure, for example, a one-way clutch having ratchet teeth.

What is claimed is:

1. A recording apparatus comprising:
a conveyance path for conveying a medium;
a recording head configured to perform recording on the medium in the conveyance path;
a first roller pair provided upstream of the recording head in the conveyance path and configured to convey the medium;
a second roller pair provided downstream of the recording head in the conveyance path and configured to convey the medium;
a cap facing the recording head;
a suction pump coupled to the cap;
a motor that is a common driving source for the first roller pair, the second roller pair, and the suction pump;
a first power transmission section configured to transmit power of the motor to the first roller pair and the second roller pair;
a second power transmission section configured to set, as a forward rotation direction, a rotation direction of the motor at a time when the medium is conveyed downstream by the first roller pair and the second roller pair and transmit the power of the motor to the suction pump when the motor rotates in a reverse rotation direction opposite to the forward rotation direction; and
a clutch provided between, of the second roller pair, a drive roller driven by the power of the motor and the first power transmission section, wherein
the clutch transmits the power of the motor when the motor rotates in the forward rotation direction and interrupts the transmission of the power of the motor when the motor rotates in the reverse rotation direction.

2. The recording apparatus according to claim 1, wherein
the clutch includes:
a first gear configured to rotate together with the drive roller;
a second gear configured to mesh with the first gear when the motor rotates in the forward rotation direction and not to mesh with the first gear when the motor rotates in the reverse rotation direction; and
a third gear to which power is transmitted from the first power transmission section, the third gear transmitting power to the second gear,
the first gear, the second gear, and the third gear are disposed along a rotation axis of the drive roller,
the first gear includes a first tooth protruding toward the second gear,
the second gear includes a second tooth protruding toward the first gear, and
the second tooth meshes with the first tooth when the motor rotates in the forward rotation direction and does not mesh with the first tooth when the motor rotates in the reverse rotation direction.

3. The recording apparatus according to claim 2, wherein
a first inclined surface inclined in a direction in which a tooth height decreases from the first tooth is formed in the first gear, and
the second tooth slides on the first inclined surface when the motor rotates in the reverse rotation direction.

4. The recording apparatus according to claim 3, wherein
the second gear includes a third tooth and a fourth tooth protruding toward the third gear,
the third tooth and the fourth tooth are provided at an interval in the rotation direction,
the third gear includes a fifth tooth protruding toward the second gear,
the fifth tooth meshes with the third tooth when the motor rotates in the forward rotation direction and meshes with the fourth tooth when the motor rotates in the reverse rotation direction,
when the fifth tooth meshes with the third tooth, movement of the second gear along the rotation axis is restricted between the first gear and the third gear to maintain a state in which the first tooth and the second tooth mesh with each other, and
when the fifth tooth meshes with the fourth tooth, movement of the second gear along the rotation axis is allowed between the first gear and the third gear and thus the second tooth slides on the first inclined surface.

5. The recording apparatus according to claim 4, wherein
the third gear includes a sixth tooth protruding toward the second gear,
the fifth tooth and the sixth tooth are provided at an interval in the rotation direction, and
the sixth tooth meshes with the fourth tooth when the motor rotates in the forward rotation direction and meshes with the third tooth when the motor rotates in the reverse rotation direction.

6. The recording apparatus according to claim 2, wherein a plurality of the first teeth are provided in the first gear at intervals in the rotation direction.

7. The recording apparatus according to claim 6, wherein a plurality of the second teeth are provided at intervals in the rotation direction in the second gear.

8. A recording apparatus comprising:
a conveyance path for conveying a medium;
a recording head configured to perform recording on the medium in the conveyance path;
a first roller pair provided upstream of the recording head in the conveyance path and configured to convey the medium;
a second roller pair provided downstream of the recording head in the conveyance path and configured to convey the medium;
a cap facing the recording head;
a suction pump coupled to the cap;
a motor that is a common driving source for the first roller pair, the second roller pair, and the suction pump;
a first power transmission section configured to transmit power of the motor to the first roller pair and the second roller pair; and
a second power transmission section configured to set, as a forward rotation direction, a rotation direction of the motor at a time when the medium is conveyed downstream by the first roller pair and the second roller pair and transmit the power of the motor to the suction pump when the motor rotates in a reverse rotation direction opposite to the forward rotation direction, wherein
the second roller pair includes:
a drive roller driven by the motor; and
a driven roller driven to rotate while nipping the medium between the driven roller and the drive roller,
the driven roller is rotatably supported by a movable frame,
the movable frame is displaceable to a first position where the driven roller is capable of nipping the medium between the driven roller and the drive roller and a second position where the driven roller separates from the drive roller, and
the movable frame is disposed at the first position when the motor rotates in the forward rotation direction and is disposed at the second position when the motor rotates in the reverse rotation direction.

9. The recording apparatus according to claim 8, further comprising:
a carriage movable in a width direction intersecting a conveyance direction of the medium and including the recording head; and
a slide member that is a member configured to engage with the movable frame, when the carriage moves to an outer side of a recording region where recording is performed on the medium, the slide member receiving, from the carriage, an external force moving in the width direction, wherein
the movable frame is pressed toward the second position by a pressing member, and
when the external force is not received from the carriage, the slide member holds the movable frame at the first position against a pressing force of the pressing member and receives the external force from the carriage and moves in the width direction to allow displacement of the movable frame toward the second position.
